(19) United States
(12) Patent Application Publication
(10) Pub. No.: US 2025/0229538 A1
(43) Pub. Date: Jul. 17, 2025

(54) PRINTHEAD OF AN INKJET PRODUCT LABELLING SYSTEM

(71) Applicant: Weber Marking Systems GmbH, Rheinbreitbach (DE)

(72) Inventors: Lars MAELZER, Lübeck (DE); Ingo BECKER, Bonn (DE)

(21) Appl. No.: 18/854,196

(22) PCT Filed: Apr. 4, 2023
(86) PCT No.: PCT/DE2023/200071

§ 371 Date: Oct. 4, 2024

(30) Foreign Application Priority Data
Apr. 6, 2022 (DE) 10 2022 203 444.9

(51) Int. Cl. B41J 2/175

(52) U.S. Cl. CPC B41J 2/1752; B41J 2/17526; B41J 2/17553

(57) ABSTRACT

A printing head of an ink jet product lettering system includes a printing head housing (2), a cartridge space (6) for an ink cartridge (8), said cartridge space (6) being formed in the printing head housing (2) as well as with movable cartridge guide element (22; 22′) which is arranged in the printing head housing (2) and which includes a receiver (26). The receiver (26) is adapted to the ink cartridge (8) which is to be received and into which receiver (26) at least one section (28) of the ink cartridge (8) can be inserted. The cartridge guide element (22; 22′) is configured such that given its movement it defines a predefined movement path, along which an ink cartridge (8) which is inserted into the receiver (26) is moved into a predefined operating position in the cartridge space (6). An ink jet printing system has such a print head.

### CROSS REFERENCE TO RELATED APPLICATIONS

This application is a United States National Phase Application of International Application PCT/DE2023/200071, filed Apr. 4, 2023, and claims the benefit of priority under 35 U.S.C. § 119 of German Application 10 2022 203 444.9, filed Apr. 6, 2022, the entire contents of which are incorporated herein by reference.

### TECHNICAL FIELD

The invention relates to a printing head of an ink jet product marking or lettering system as well as to an ink jet printing system with such a printing head.

### BACKGROUND

Ink jet product marking or lettering systems are applied in order to print products and/or product packages, for example with batch numbers, sell-by-dates etc. in industrial manufacturing and packaging processes. For this, one uses printing heads which by way of an ink jet print products or packages which are moved past the printing head. Such a printing head is known for example from DE 10 2008 026 667 B4. The printing heads are each configured for use with a certain type of ink cartridge. These ink cartridges are exchangeable and form a construction unit consisting of an ink tank and printing nozzles, wherein the ink cartridges in particular can be configured for printing according to the thermo-inkjet principle. The ink cartridges comprise electrical connection contacts for the control of the integrated printing nozzles, said contacts as a rule being grouped together in a connection field. The connection field comprises a multitude of contact points which lie next to one another and which can be embedded in a foil structure. On inserting the ink cartridge into the printing head, this connection field comes into bearing contact with a contact field in the printing head. The contact field in the printing head comprises a multitude of connection contacts which are arranged in a manner corresponding to the contact points of the connection field of the ink cartridge. The connection contacts in the printing head can be configured for example as spring pins. With regard to known ink cartridges, the connection field lies on a side wall which in an adjacent manner extends at an angle of 90 degrees to the front face wall of the ink cartridge, in which face wall the printing nozzles are formed.

In order for the printing nozzles to be able to be brought as closely as possible to the product on printing the products being moved past, the printing nozzles need to be placed as closely and directly as possible to a face wall of the printing head which faces the product. As a rule, a sealing is simultaneously necessary in this region in order to be able to protect the inside of the printing had from contamination. The ink cartridge with the region which surrounds the printing nozzles thus preferably bears on the inner side of a face wall of the printing head. On inserting the ink cartridge into the printing head, the ink cartridge must herewith be simultaneously moved against the face wall and against the contact field in the inside of the printing head, which necessitates a complex insertion movement, concerning which the contacts of the contact field in the inside of the printing head can become easily damaged when not taking care.

### SUMMARY

Against the background of such problems, it is an object of the invention to improve a printing head for use in an ink cartridge, to the extent that a simpler insertion of the ink cartridge into the printing head is possible without damage to the connection contacts.

This object is achieved by a printing head of an ink jet product marking or lettering system with features according to the invention as well as by an ink jet printing system with features according to the invention. Preferred embodiments result from this disclosure, including the description, figures and claims.

The printing head according to the invention is envisaged for use in an ink jet product lettering system. I.e. the invention relates to a printing head of such an ink jet product lettering system. This is a product lettering system which is envisaged for printing the products by way of a relative movement of the products along the printing head. The printing head comprises printing head housing, in whose inside a cartridge space is formed, into which space an ink cartridge can be inserted in an exchangeable manner. Herein, this is a certain type of ink cartridge, i.e. the printing head is configured for a certain type of ink cartridge. Such ink cartridges which form a construction unit of an ink tank and a printing nozzle arrangement are available on the market from different manufacturers. The printing head in its geometry is adapted to a certain type of ink cartridge, so that such an ink cartridge can be received in the printing space and be electrically controlled by the printing head. Preferably, the printing head housing is configured in a completely closed manner, so that the cartridge space into which the ink cartridge is inserted can be sealingly closed, for example by way of a lid, after the insertion of the ink cartridge, and the inside of the printing head is protected from contamination or also moisture.

In order to permit a defined insertion of the ink cartridge into the cartridge space, according to the invention a movable cartridge guide element is arranged in the printing head housing. This cartridge guide element comprises a receiver which in its geometry is adapted to the ink cartridge to be received such that the ink cartridge can be inserted into the receiver of the cartridge guide element and thus be held in the cartridge guide element. For this, for example projections on the ink cartridge can engage into the receiver or the receiver can be configured e.g. such that it encloses the ink cartridge as a whole from one side.

Moreover, the cartridge guide element is configured in a manner such that given its envisaged movement, it defines a predefined movement path, along which the ink cartridge which was previously inserted into the receiver is moved into a predefined operating position in the cartridge space. I.e. the movement course for inserting the ink cartridge into the cartridge space, i.e. for moving the ink cartridge into the final operating position, according to the invention is defined by the cartridge guide element so that the movement is effected along a defined movement path and is not at the discretion of an user. Hence in particular it can be ensured that the ink cartridge is moved relative to the electrical connection contacts in a defined manner, so that damage to the contacts on insertion can be avoided. The precise contour of the defined movement path depends on the geometry of the applied ink cartridge and is herewith adapted to the special ink cartridge for which the printing head is configured. The movement path in particular can define movements in at least two different directions which can be effected in a successive or superimposed manner. Thus the ink cartridge can be moved with the printing nozzles in front against an inner wall of the cartridge space and in the direction of its connection contacts against a contact field in the inside of the cartridge space, for example in a simultaneous and/or successive manner. These movements can be effected successively or at least partly in a superimposed manner, but however according to the invention are set by the design and arrangement of the cartridge guide element in a manner such that on insertion the ink cartridge is moved along the movement path or a predefined path.

Preferably, the cartridge guide element is configured in a manner such that it defines a movement path for an ink cartridge which is inserted into the receiver, said path consisting of a combined pivoting movement and linear movement. Thus for example the pivoting movement can serve for bringing the electrical connection contacts or a connection field of the ink cartridge into contact with electrical contacts or a contact field in the cartridge space, whereas the linear movement is used to press a wall of the ink cartridge which comprises the printing nozzles against an inner wall and/or a seal in the cartridge space. Preferably, the linear movement begins after the pivoting movement, wherein the linear movement can be effected after completion of the pivoting movement or at least partly superimposed with this. If the linear movement is utilized for pressing the ink cartridge onto a contact surface and/or seal, then it is advantageous if the linear movement forms the last section of the movement path, in order e.g. to keep the friction forces low during the pivoting movement.

As already mentioned, the printing head in the cartridge space preferably comprises a contact field for the electrical contacting of a connection field of the ink cartridge. In particular, a control of the printing nozzles which are formed in the ink cartridge can be effected via the electric connections by control electronics which are integrated in the printing head. The design of the cartridge guide element and the defining of the movement path are such that the connection field of the ink cartridge is brought into contact with the contact field in the cartridge space by way of the movement of the ink cartridge along the predefined movement path. Herein, the ink cartridge is preferably moved to the contact field such that the contact field and the connection field preferably come into contact in a direction transverse to the plane which is spanned by the connection field. Hence for example one succeeds in contact pins in the contact field coming to bear directly on the free contact fields or contact points of the connection field without damaging a foil structure of the connection field.

Preferably, the cartridge guide element is pivotably mounted in the printing head housing so that it is pivoted for its movement. Preferably, the pivotable mounting is configured such that it is pivotable from a first into a second position and in the second position the connection field of an ink cartridge which is inserted into the cartridge guide element is in contact with the contact field in the cartridge space. I.e. preferably the pivotability of the cartridge guide element is configured such that by way of the pivoting from the first position into the second position the contacts in the connection field of the inserted ink cartridge are brought into contact with the contacts in the contact field of the cartridge space. Herein, the contacts preferably follow an arcuate path course about a pivot axis which is set by the mounting of the cartridge guide element.

According to a further preferred embodiment, the printing head comprises a pivotable lid which is configured such that it closes the cartridge space, preferably in a sealed manner, in a closed position. For this, a seal can be provided between the lid and the adjacent printing head housing. The pivotable lid is preferably arranged relative to the cartridge guide element such that on closing it acts upon the cartridge guide element or upon an ink cartridge which is inserted into this, and by way of this moves the cartridge guide element. For this, the lid can come into bearing contact with the cartridge guide element or the inserted ink cartridge in a direct or indirect manner, so that a force is exerted by the lid upon the cartridge guide element, said force moving the cartridge guide element with an inserted ink cartridge along the predefined movement path or at least along a section of this movement path. The closing of the lid herein preferably effects a pressure force upon the cartridge guide element, said force moving this from the first position which is described above into the second position and herein further preferably bringing the connection field into contacting bearing contact with the contact field. A spring element whose spring force is overcome by pressure upon the lid can be provided for the moving-back. Such a spring element preferably acts upon the cartridge guide element. Alternatively, it is also possible for the cartridge guide element to be connected to the lid or part of the lid, so that it can be moved together with the lid.

Further preferably, the pivotable lid is arranged relative to the cartridge guide element in a manner such that the cartridge guide element is pivoted from its first into its second position by way of closing the lid.

The lid is preferably a first contact element, for example in the form of a roller which is arranged such that on closing the lid it comes to bear on the inserted ink cartridge, in order to move this together with the cartridge guide element, in particular in order to pivot it about the described pivot axis. The design of the contact element as a roller has the advantage that given the movement, the contact element can roll on the surface of the ink cartridge. Instead of a roller however, one can also provide a different contact element, for example a contact element which slides upon the surface of the ink cartridge.

According to a further preferred embodiment of the invention, the receiver in the cartridge guide element is matched to the ink cartridge to be received, i.e. in particular to the outer geometry of the ink cartridge, such that the ink cartridge is linearly movable in the receiver in at least one direction. This linear movability herein preferably forms a part of the aforementioned predefined movement path on insertion of the ink cartridge into the cartridge space. Preferably, the movement path is defined by the described pivoting movement of the cartridge guide element and by the linear movement of the ink cartridge in the receiver. The pivoting movement and the linear movement can herein be effected successively or at least in part simultaneously. The linear movement is preferably effected when the cartridge guide element is situated in its second position. If in the second position the electrical contacts of the connection field are in bearing contact with the electrical contacts of the contact field in the printing space, then the contacts slide along one another given this linear movement.

According to a further possible embodiment of the invention, the receiver is matched to the ink cartridge to be received, in a manner such that the ink cartridge is movable, in particular linearly movable in the receiver in a direction transverse to a pivot axis of the cartridge guide element. The receiver and the ink cartridge are herein matched to one another such that they preferably permit a linear movement by a predefined amount. The movability transversely to the direction of the pivot axis permits the ink cartridge to move or displace in the cartridge guide element in a linear manner essentially in the radial direction with respect to the pivot axis. By way of the pivoting movement from the mentioned first into the second position, this permits the connection field to firstly be brought into bearing contact with the contact field and then preferably permits the linear displacement of the ink cartridge in the receiver by an amount, in order for example to bring it to bear on a wall or inner wall of the cartridge space.

According to a further possible design, the printing head preferably comprises a pressing element which is arranged and configured such that in its operational position it presses the ink cartridge which is inserted into the guide element against a stop and/or a wall or inner wall of the cartridge space. Herein, the pressing element can be arranged and configured such that it also effects the described movement of the ink cartridge in the receiver of the cartridge guide element by way of it pressing against the cartridge guide element and/or against the ink cartridge and displacing this, preferably in a linear manner. Due to the fact that the pressing element presses the ink cartridge against a stop or a wall of the cartridge space in its operating position, the ink cartridge is reliably fixed in the operating position.

The pressing element can comprise for example a spring element which generates a pressing force, and/or a pressing lever. Such a pressing lever can be configured for example in the manner of a toggle lever. Such a pressing lever comprises a contact surface or a contact point which preferably comes into bearing contact with the ink cartridge in order to transmit a force onto the ink cartridge. Furthermore, it preferably comprises a force engagement point, upon which an actuation force acts upon the lever. This actuation force can for example be mustered by a spring element or particularly preferably also by the described lid.

Thus in one possible embodiment, the pivotable lid preferably comprises a second contact element which is configured and arranged in a manner such that on closing the lid it acts upon the pressing element for subjecting the ink cartridge to force. Thus on closing the lid, for example via a pressing element which is configured as a lever system, the necessary force is simultaneously exerted upon the ink cartridge in order to fix this in a defined operating position. The contact element can be configured as an elastic element, for example as an elastomer element in order to generate an elastic contact force.

According to a further preferred embodiment of the invention, the pivot axis about which the cartridge guide element can be pivoted is essentially parallel to a plane which is spanned by the contact field. Herein, the pivot axis further preferably extends transversely or normally to a longitudinal axis of the ink cartridge which extends parallel to the exit direction of the ink droplets, i.e. from a front side which comprises a nozzle arrangement to the distant rear side. Hence the pivot axis further preferably extends parallel to a surface in which the nozzles are formed in the ink cartridge. By way of this arrangement, one succeeds in a connection field of the ink cartridge being able to be brought into bearing contact with the contact field in the inside of the cartridge space by way of a pivoting movement of the cartridge guide element. Herein, the pivot axis can be a virtual pivot axis or a physical pivot.

A virtual pivot axis can be achieved for example by way of the cartridge guide element being pivotably mounted in recesses in the side surfaces of the printing head housing.

According to a further possible design, the cartridge guide element is configured in a manner such that it permits a linear movement of an ink cartridge which is inserted into the receiver, parallel to a plane which is spanned by the contact field, preferably, when the cartridge guide element is located in its second position as has been described above. Thus a part of the predefined movement path can be effected as a linear movement parallel to the connection field as has been described above. Herein, electrical contacts can slide on one another, by which means the electrical contacting can be simultaneously improved.

Preferably, the cartridge guide element is configured such that in the second position of the cartridge guide element it permits a linear movement of an ink cartridge which is inserted into the receiver, in a direction parallel to a plane which is spanned by the contact field, by an amount which is smaller than the extension of the contacts of the connection field of the ink cartridge in this direction. This amount is preferably defined by a predefined play in the receiver for an inserted ink cartridge, so that the ink cartridge can move linearly only about the amount which is defined by this play. If this amount is smaller than the extension of the electrical connection contacts, then one succeeds in the electrical connection contacts of the contact field and the connection field sliding on one another over the whole linear movement and the electrical connection contacts of the contact field not coming into contact with a foil structure of the connection field which surrounds its electrical contacts. I.e. the connection contacts preferably come into bearing contact with one another and then displace linearly to one another by an amount which is smaller, preferably smaller than half the extension of the connection contacts of the connection field in this direction. Damage to the foil structure is therefore prevented.

The cartridge space is preferably delimited by a face wall which in operation faces the product to be printed. The face wall comprises an opening, on which a nozzle arrangement of an ink cartridge which is inserted into the cartridge space comes to bear, so that ink droplets can exit out of the nozzles of the nozzle arrangement and can move through the opening towards a product to be printed. The face wall is herein configured as thinly as possible, in order to be able to bring the nozzles of the nozzle arrangement as closely as possible onto the product to be printed. The face wall is preferably that wall or inner wall of the cartridge space, against which an ink cartridge which is inserted into the cartridge space comes to bear, as has been described above.

The face wall of the cartridge space thus preferably in the circumferential region of the mentioned opening forms a contact surface for an ink cartridge which is inserted into the cartridge space, so that this comes to bear on the contact surface. Herein, the ink cartridge is preferably pressed against the contact surface by the aforedescribed pressing element. Further preferably, a seal is arranged on the contact surface, so that the ink cartridge comes to bear on the seal and hence the region between the face wall and the ink cartridge is sealed off by the seal.

The pivot axis, for example a physical pivot or also a virtual pivot axis of the cartridge guide element is further preferably situated between the mentioned face wall and a contact field which is arranged in the cartridge space. Alternatively, the pivot axis can also be situated for example on a side of the contact field which is away from the face wall. Both arrangements permit an ink cartridge which is inserted into the cartridge guide element to pivot with the cartridge guide element such that a connection field of the ink cartridge is brought in an arcuate movement to the contact field in the cartridge space and is brought into bearing contact with the contact field.

Apart from the aforedescribed printing head of an ink jet product lettering system, the invention also relates to an ink jet printing system for use in such a product lettering system, wherein the ink jet printing system comprises a printing head as has been described previously and at least one exchangeable ink cartridge which can be inserted into the printing head. Herein, it is the case of an ink cartridge which is adapted to the printing head which is to say it is a printing head which is adapted the ink cartridge. Apart from this printing system, the subject-matter of the invention is also a method for inserting an ink cartridge into such a printing head, wherein the ink cartridge according to this method, as has been described above, is moved along a predefined movement path into the printing space of the printing head. I.e. the movement path is fixedly set by the geometric design of the printing head and is not at the discretion of the user. Further preferred embodiments of the printing system and the method result from the preceding description of the printing head, which is referred to here.

The invention is hereinafter described by way of example by way of the attached figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective view of a partly opened printing head according to a first embodiment of the invention;

FIG. 2 is a lateral view of the printing head according to FIG. 1 on inserting the ink cartridge;

FIG. 3 is a perspective view of the printing head according to FIGS. 1 and 2 in a first step of the closing of the lid;

FIG. 4 is a view according to FIG. 3 in a second step of the closing of the lid;

FIG. 5 is a lateral view according to FIG. 2 in a third step of the closing of the lid;

FIG. 6 is a view according to FIG. 5 with a lid which is closed further;

FIG. 7 is a view according to FIGS. 5 and 6 with a completely closed lid;

FIG. 8 is a perspective view of a partly opened printing head according to a second embodiment of the invention before the insertion of an ink cartridge;

FIG. 9 is a view according to FIG. 8 with an inserted ink cartridge;

FIG. 10 is a view according to FIG. 9 with a partly pivoted-in cartridge guide element; and

FIG. 11 is an opened lateral view of the printing head according to FIGS. 8 to 10 with the ink cartridge in its operation position.

### DESCRIPTION OF PREFERRED EMBODIMENTS

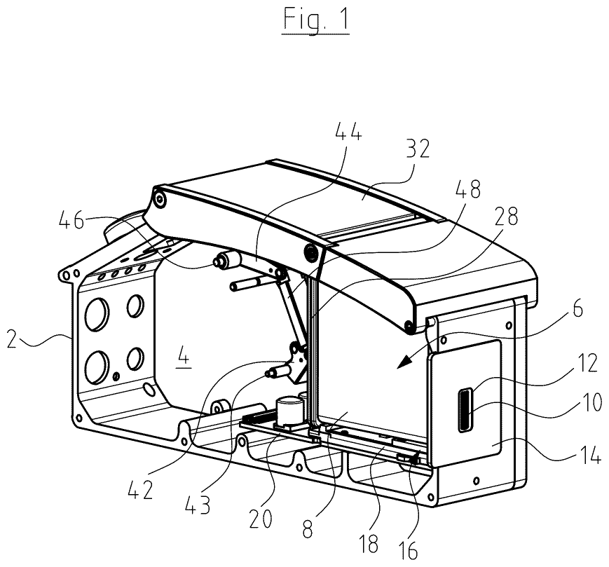

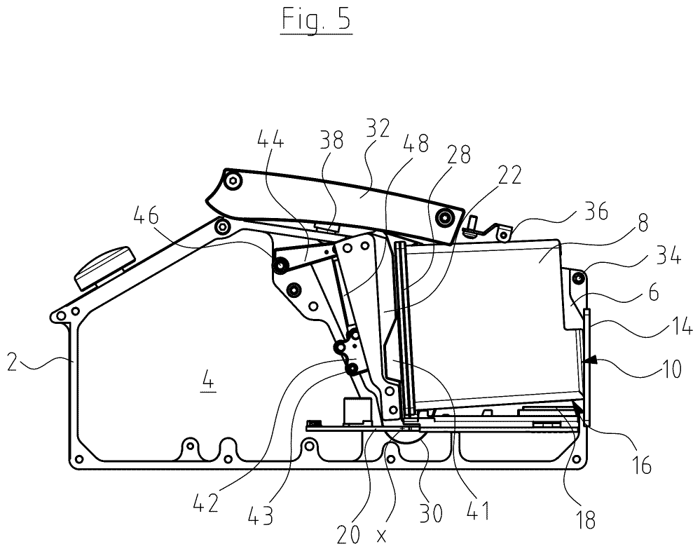

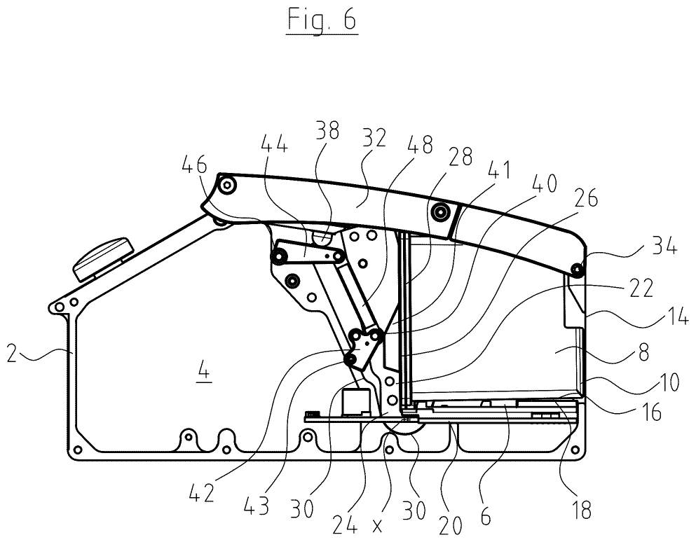

Referring to the drawings, a first embodiment of the invention is described by way of FIGS. 1 to 7. The shown printing head comprises a printing head housing 2 from which a side wall is removed in the shown views in order to free the view into the inside. In the rear region, the printing head housing comprises an electronics receiving space 4 for control electronics which are not shown here. In the front region which faces the object to be printed, the printing head housing 2 comprises a cartridge space 6 in which an ink cartridge 8 is received. The ink cartridge 8 comprises a nozzle arrangement 10 on its front end-face. In the inserted state, i.e. the operating state, the ink cartridge 8 is arranged in the cartridge space 6 such that the nozzle arrangement 10 is situated behind an opening 12 in the front face wall 14. The front face wall 14 with the opening 12 faces a product which is to be printed, wherein the product to be printed is led past the printing head parallel to the face wall 14 and is printed from ink droplets which exit from the nozzle arrangement 10 during the movement.

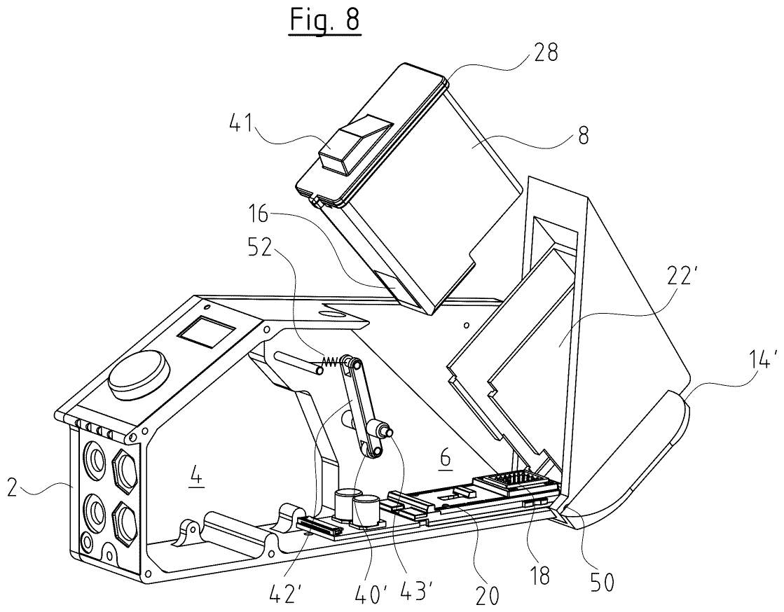

A connection field 16 with electric contacts for controlling the nozzle arrangement 10 is formed in the ink cartridge 8 on a side wall which is adjacent to the front side, in the figures on the lower side of the ink cartridge 8 (see also FIG. 8). A contact field 18 with electrical contacts in the form of resilient contact pins is arranged in the cartridge space 6 for contacting this connection field 16. The contact field 18 is arranged on a circuit board 20 which carries control electronics which are adapted to the ink cartridge 8. The circuit board 20 is connected to further electronic components for the control of the printing head, in the electronics receiving space 4. With regard to the ink cartridge 8 it is a certain type of cartridge, i.e. a standard product and the complete printing head is adapted to this specific ink cartridge. In the shown example, it is an ink cartridge 8 of the manufacturer Funai (Lexmark). The printing head however in a suitable manner could also be adapted to a different type of ink cartridge. Such adaptations relate to the exact geometry and the design of the circuit board 20 with the contact field 18.

Since the ink droplets which leave the nozzle arrangement 10 are to hit the product to be printed with an adequate speed or energy, the distance between the nozzle arrangement and the product to be printed should not be too large. For this reason, the nozzle arrangement 10 must be brought very closely to the outer surface of the front face wall 14, i.e. the front face wall 14 must be configured sufficiently thinly. At the same time, a sealing should be achieved in this region, for which a seal can be arranged on the inner side of the front face wall 14. In order to achieve an adequate sealing effect, the ink cartridge 8 with its front side on which the nozzle arrangement 10 is situated must be pressed against the inner side of the front face wall 14, in the circumferential region of the opening 12. The lower side of the ink cartridge 8 with the connection field 16 which is arranged there must simultaneously be pressed onto the contact field 18. On insertion of the ink cartridge 8, this requires a movement in two directions, specifically to the front and to the bottom.

In order to execute this movement in a defined manner and to herein prevent damage to the electrical connection contacts of the contact field 18 as well as to the connection field 16 due to improper insertion, according to the invention a cartridge guide element 22 is arranged in the printing head. The cartridge guide element 22 serves for moving the ink cartridge 8 into the operating position in the cartridge space 6 in a defined manner. The cartridge guide element 22 is configured in a fork-like manner with two plates 24 which are distanced to one another and between which the ink cartridge 8 is arranged. The plates 24 on the inner surfaces which face one another each comprise a groove 26, into which a laterally projecting projection 28 engages at the rear-side end of the ink cartridge 8. Herein, the groove 26 has a width which is slightly larger than the width of the projection 28, so that the projection 28 has a certain play in the groove 26 in the transverse direction. The cartridge guide element 22 is shaped in a circular-arc-shaped manner at its lower end and is pivotably mounted in a correspondingly shaped recess 30 in the respective side wall of the printing head housing 2. The recess 30 is likewise shaped in a circular-arc-shaped manner at its base so that the cartridge guide element 22 can rotate in the recess 30. Herein, the recess 30 is configured essentially as the plates 24 in the manner of a “piece of cake”, wherein the recess 30 has a larger opening angle than the plates 24, so that the plates 24 can pivot in the recesses 30 about the pivot axis X by a certain angular range. This pivoting movement is initiated by way of closing the lid 32 in the subsequently described manner.

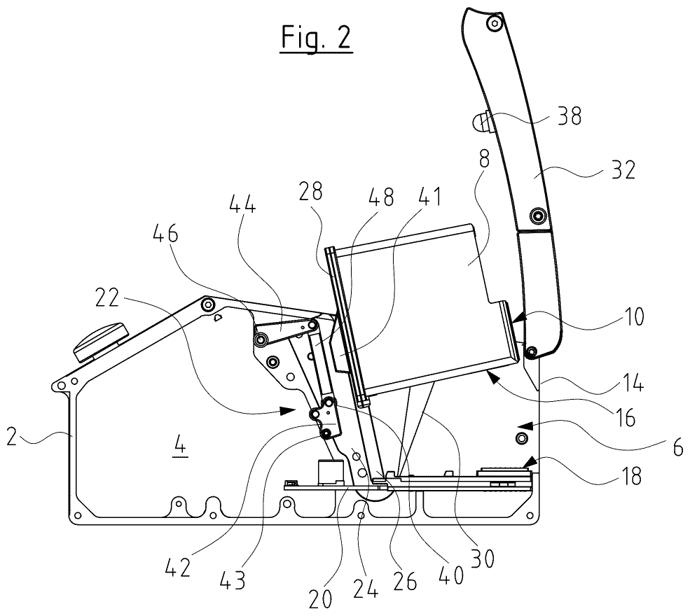

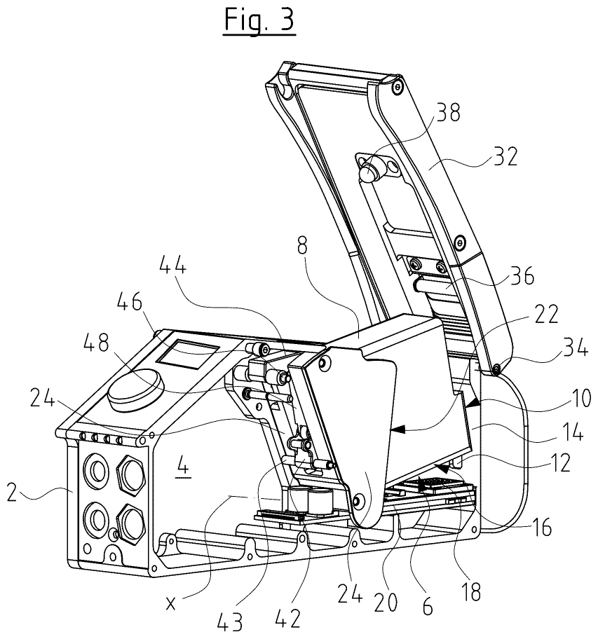

For inserting the ink cartridge 8, the cartridge guide element 22 with the plates 24 is situated in a first position, in which it is pivoted away from the front face wall 14 of the printing head housing 2. Springs hold the cartridge guide element in this idle position. In this position which is shown in FIG. 2, the ink cartridge 8 with the projection 28 is inserted into the groove 26. FIG. 3 shows the state in which the ink cartridge 8 is completely inserted into the cartridge guide element 22. The cartridge guide element 22 is still located in the first position.

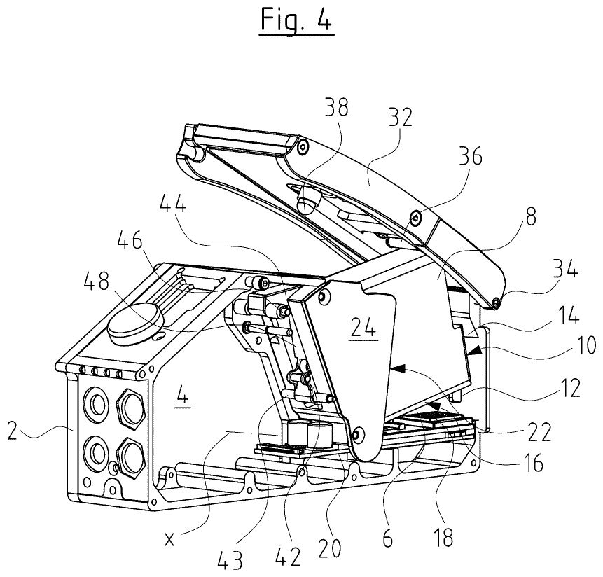

A first contact element 36 and a second contact element 38 are arranged on the inner side of the lid 32, said lid being pivotable close to the front face wall 14 about a pivot axis 34. The first contact element 36 is configured in a roller-like manner and is provided for contact with the upper side of the ink cartridge 8. The second contact element 38 is configured as an elastic pressing element. On closing the lid 32, for which the lid 32 is pivoted about the pivot axis 34, the first contact element 36 comes into contact with the upper side surface of the inserted ink cartridge 8, as is shown in FIG. 4. The further the lid 32 is closed, the further does the first contact element 36 press the ink cartridge 8 downwards, so that the connection field 16 is moved to the contact field 18 in a pivoting manner. Herein, the cartridge guide element 22 pivots about the pivot axis X in the recess 30. The roller-like first contact element 36 herein slides along the upper side of the ink cartridge 8 or rolls on this.

In order to achieve a displacement or linear movement of the ink cartridge 8 in the direction of the front face wall 14 in the further course of the movement of the ink cartridge 8, according to the invention a pressing element 40 is arranged on the cartridge guide element 22. The pressing element 40 is configured in a roller-like manner and comes to bear on a projection 41 which is formed on the rear side of the ink cartridge 8, i.e. on the rear-side end-face 14 which is away from the nozzle arrangement. The pressing element 40 is arranged on a pivotable pressing lever 42 which is pivotable about a pivot axis 43. An actuation lever 44 which is pivotable about a pivot axis 46 is provided for the movement of the pressing element 40. The actuation lever 44 at its end which is away from the pivot axis 46 is articulately connected to a connection lever 48 which at its opposite end is articulately connected to the pressing lever 42. Herein, the connection lever 48 is connected to the pressing lever 42 at its end which is away from the pivot axis 43 and at which the pressing element 40 is also situated. Preferably, the pressing element 40 rotates about the same axis, about which the connection lever 48 can pivot with respect to the pressing lever 42.

The three levers, i.e. the actuation lever 44, the connection lever 48 as well as the pressing lever 42 together form a type of toggle-lever mechanism. On closing the lid 32, the second contact element 38 comes to bear on the actuation lever 44 so that this is pivoted about the pivot axis 46 on further closure of the lid 32. Herein, the pressing lever 42 is likewise pivoted about its pivot axis 43 via the connection lever 48, so that the pressing element 40 is pressed against the projection 41. By way of this, a pressing force which is directed to the front, i.e. a pressing force which is directed towards the front face wall 14 is exerted upon the ink cartridge 8. Herewith, the ink cartridge 8 is pushed to the front, i.e. towards the face wall 14, by the play which is present between the groove 26 and the projection 28. This linear movement or displacement is not effected until the connection field 16 comes into contact with the contact field 18, i.e. not until towards the end of the insertion movement of the ink cartridge 8. The linear displacement which is herein achieved is so small that it is smaller than the diameter, preferably than half the diameter of the contact fields in the connection field 16, so that such a displacement can be effected whilst the electrical contacts of the contact field 18 and the connection field 16 are already in bearing contact with one another. Given this movement, a seal which is arranged on the inner side of the front face wall 14 can be simultaneously compressed, in order to achieve a good sealing effect.

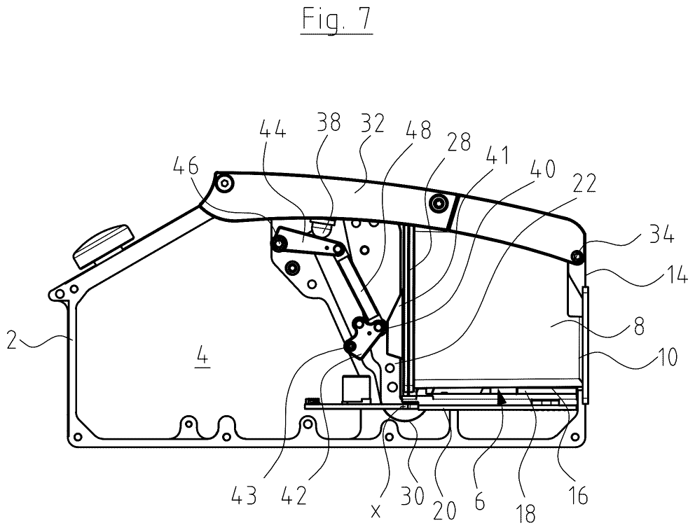

FIG. 7 finally shows the end position of the ink cartridge 8 in the cartridge space 6, i.e. the operating position of the ink cartridge 8, in which position this can then be used for printing. In this operating position, the electrical contacts between the connection field 16 and the contact field 18 are in bearing contact and the ink cartridge 8 is simultaneously pressed against the inner side of the front face wall 14. In order to generate a biasing force in this direction, the second contact element 38 is preferably configured in an elastic manner, so that it exerts an elastic pressing force upon the actuation lever 44 in the closed state of the lid 32. In the position which is shown in FIG. 7, the printing head housing 2 is completely closed, so that the interior is protected from contamination and penetrating humidity. For this, an additional seal can be arranged below the lid 32. As described, the cartridge guide element 22 together with the pressing element 40 and the described lever mechanism generates a defined movement path for guiding or inserting the ink cartridge 8 into the cartridge space 6. This movement path is achieved by the described initial pivoting movement of the ink cartridge 8 together with the cartridge guide element 22 and the subsequent superimposed linear movement by way of displacing the ink cartridge 8 in the groove 26.

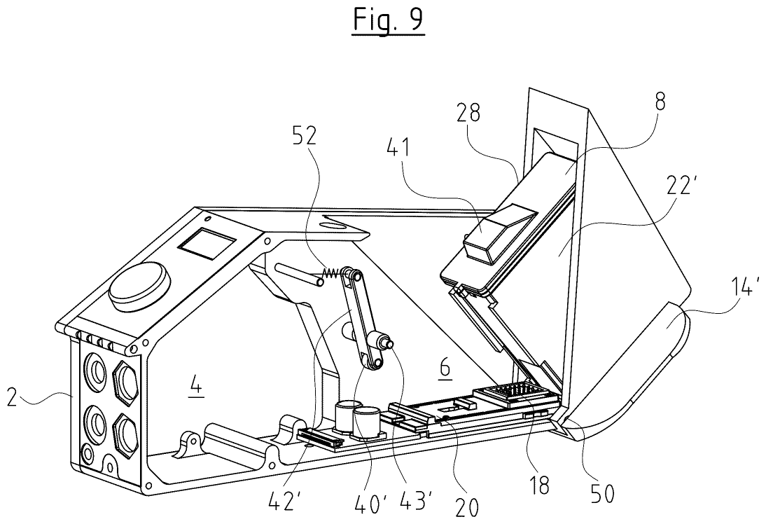

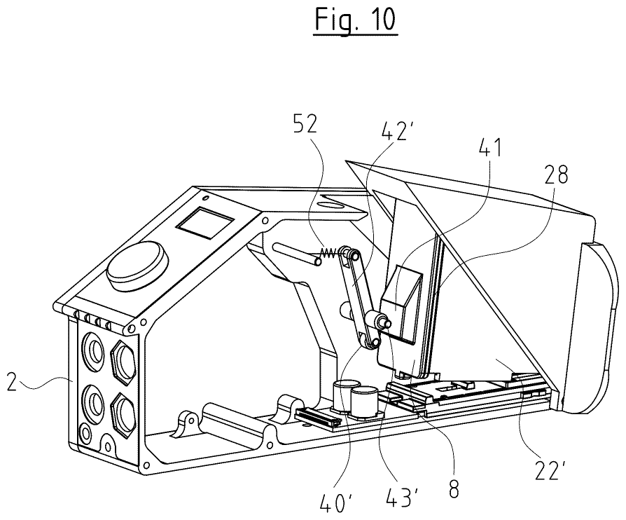

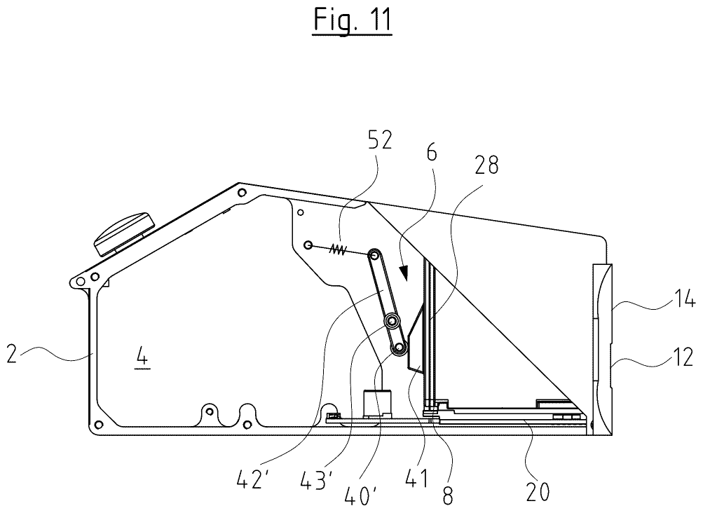

FIGS. 8 to 11 show a second embodiment example of the invention. In the second embodiment example, the printing head housing 2 is configured essentially the same as the printing head housing 2 according to the first embodiment. The ink cartridge 8 is configured identically and the circuit board 20 with the contact field 18 is also configured identically and arranged in an identical manner in the printing head housing 2. In the second embodiment example, the cartridge guide element 22′ is configured as a unit with the front face wall 14′ and is pivotable about a pivot axis 50 which is arranged in the region of the front face wall 14′. I.e. in the second embodiment example, the cartridge guide element 22′ pivots to the front and not to the rear for inserting the ink cartridge 8, as in the first embodiment example. As is shown in FIG. 8, the ink cartridge 8 can be pushed into the cartridge guide element in the pivoted-forwards state, i.e. in the first position of the cartridge guide element 22′, so that the ink cartridge 8 is received in the cartridge guide element 22′ as is shown in FIG. 9. The cartridge guide element can subsequently be pivoted about the pivot axis 50 as is shown in FIG. 10, so that the ink cartridge 8 with its connection field 16 is moved to the contact field 18 on the circuit board 20. Given the further movement, the projection 41 with a pressing element 40′ comes to bear on a pivotable pressing lever 42′. The pressing lever 42′ is pivotable about a pivot axis 43′. Herein, the pivot axis 43′ lies in the middle region of the pressing lever 42′. The pressing element 40′ lies at one end of the pressing lever 42′. A spring element 52 which is configured as a tension spring engages at the opposite end and by way of pivoting the pressing lever 42′ generates a pressing force between the pressing element 40′ and the projection 41, said pressing force pressing the ink cartridge 8 against the inner surface of the front face wall 14. I.e. with this second embodiment too, a defined insertion movement for the ink cartridge 8 is created along a predefined movement path which is effected by the pivoting movement of the cartridge guide element 22′ about the pivot axis 50 and the linear displacement on account of the pressing force exerted upon the projection 41.

While specific embodiments of the invention have been shown and described in detail to illustrate the application of the principles of the invention, it will be understood that the invention may be embodied otherwise without departing from such principles.

### LIST OF REFERENCE NUMERALS

2 printing head housing
4 electronics receiving space
6 cartridge space
8 ink cartridge
10 nozzle arrangement
12 opening
14 front face wall
16 connection field
18 contact field
20 circuit board
22, 22′ cartridge guide element
24 plates
26 groove
28 projection
30 recess
32 lid
34 pivot axis of the lid
36 first contact element
38 second contact element
40,40′ pressing element
41 projection
42, 42′ pressing lever
43,43′ pivot axis
44 actuation lever
46 pivot axis
48 connection lever
50 pivot axis
52 spring element
X pivot axis

1. A printing head of an ink jet product lettering system the printing head comprising:
a printing head housing with a cartridge space for an ink cartridge, said cartridge space being formed in the printing head housing; and
a movable cartridge guide element which is arranged in the printing head housing and which comprises a receiver, said receiver being adapted to the ink cartridge which is to be received and into which receiver at least one section of the ink cartridge can be inserted, wherein the cartridge guide element is designed in a manner configured such that given movement of the cartridge guide element, the cartridge guide element defines a predefined movement path, along which an ink cartridge which is inserted into the receiver is moved into a predefined operating position in the cartridge space.

2. A printing head according to claim 1, wherein the cartridge guide element defines the movement path for the ink cartridge which is inserted into the receiver, said movement path consisting of a combined pivoting movement and linear movement.

3. A printing head according to claim 1, further comprising a contact field for electrical contacting of a connection field of the ink cartridge wherein the contact field is situated in the cartridge space and the cartridge guide element is configured and the movement path defined, such that the connection field of the ink cartridge is brought into contact with the contact field in the cartridge space by way of movement of the ink cartridge along the predefined movement path.

4. A printing head according to claim 3, wherein the cartridge guide element is pivotably mounted in the printing head housing such that the cartridge guide element is pivotable from a first into a second position and in the second position the connection field of an inserted ink cartridge is in contact with the contact field in the cartridge space.

5. A printing head according to claim 1, further comprising a pivotable lid which in a closed position closes the cartridge space and which is arranged relative to the cartridge guide element such that on closing the lid acts upon the cartridge guide element or an ink cartridge which is inserted into this cartridge guide element, for moving the cartridge guide element.

6. A printing head according to claim 5, wherein the pivotable lid is arranged relative to the cartridge guide element such that the cartridge guide element is pivoted from a cartridge guide element first into a cartridge guide element second position by way of closing the lid.

7. A printing head according to claim 5, wherein the lid comprises a first contact element, arranged such that the first contact element comes to bear on the inserted ink cartridge on closing the lid, to move this ink cartridge together with the cartridge guide element.

8. A printing head according to claim 1, wherein the receiver is matched to the ink cartridge which is to be received, such that the ink cartridge is linearly movable in the receiver in at least one direction.

9. A printing head according to claim 1, wherein the receiver is matched to the ink cartridge to be received, such that the ink cartridge is movable in the receiver in a direction transverse to a pivot axis of the cartridge guide element.

10. A printing head according to claim 1, further comprising a pressing element which is arranged such that the pressing element presses the ink cartridge which is inserted into the cartridge guide element, in the operating position, against a stop and/or a wall of the cartridge space.

11. A printing head according to claim 10, wherein the pressing element comprises a spring element which generates a pressing force, and/or a pressing lever.

12. A printing head according to claim 10, further comprising a pivotable lid which in a closed position closes the cartridge space and which is arranged relative to the cartridge guide element such that on closing the lid acts upon the cartridge guide element or an ink cartridge which is inserted into this cartridge guide element, for moving the cartridge guide element, wherein the pivotable lid comprises a second contact element which is arranged such that on closing the lid the second contact element acts upon the pressing element for subjecting the ink cartridge to force.

13. A printing head according to claim 3, wherein a pivot axis about which the cartridge guide element is pivotable extends parallel to a plane which is spanned by the contact field.

14. A printing head according to claim 3, wherein the cartridge guide element is configured such that the cartridge guide element permits a linear movement of an ink cartridge which is inserted into the receiver, parallel to a plane which is spanned by the contact field.

15. A printing head according to claim 3, wherein the cartridge guide element is configured such that in the second position of the cartridge guide element the cartridge guide element permits a linear movement of an ink cartridge which is inserted into the receiver, in a direction parallel to a plane which is spanned by the contact field, by an amount which is smaller than the extension of the contacts of the connection field of the ink cartridge in this direction.

16. A printing head according to claim 1, wherein the cartridge space is delimited by a face wall which comprises an opening on which a nozzle arrangement of an ink cartridge which is inserted into the cartridge space comes to bear.

17. A printing head according to claim 16, wherein the face wall of the cartridge space in a circumferential region of the opening comprises a contact surface for an ink cartridge which is inserted into the cartridge space, wherein a seal is arranged on the contact surface.

18. A printing head according to claim 16, wherein the pivot axis of the cartridge guide element is situated between the face wall and the contact field or on a side of the contact field which is away from the face wall.

19. An ink jet printing system comprising a printing head according to claim 1, and at least one exchangeable ink cartridge which can be inserted into the printing head.

20. A printing head according to claim 2, wherein the linear movement begins after the pivoting movement.
